(19) United States
(12) Patent Application Publication
(10) Pub. No.: US 2021/0062371 A1
(43) Pub. Date: Mar. 4, 2021

(54) FABRIC

(71) Applicant: Taiwan Textile Research Institute, New Taipei City (TW)

(72) Inventors: Sheng-Mao Tseng, New Taipei City (TW); Chi-Shu Wei, New Taipei City (TW)

(73) Assignee: Taiwan Textile Research Institute, New Taipei City (TW)

(21) Appl. No.: 17/000,366

(22) Filed: Aug. 24, 2020

(30) Foreign Application Priority Data
Aug. 27, 2019 (TW) 108130696

(51) Int. Cl. D01F 6/76; D01F 1/10; D06M 10/10; D06M 15/61

(52) U.S. Cl. CPC D01F 6/76; D01F 1/10; D06M 2101/30; D06M 15/61; D06M 10/10

(57) ABSTRACT

A fabric is provided. The fabric includes a base cloth and a coating layer. The coating layer is disposed on the base cloth, and the coating layer includes a resin matrix and a temperature-regulating powder, wherein the content of the temperature-regulating powder ranges from 20 to 80 parts by weight based on 100 parts by weight of the resin matrix, and the material of the temperature-regulating powder includes modified polyaniline.

### CROSS-REFERENCE TO RELATED APPLICATION

This application claims the priority benefit of Taiwan application serial no. 108130696, filed on Aug. 27, 2019. The entirety of the above-mentioned patent application is hereby incorporated by reference herein and made a part of this specification.

### BACKGROUND

### Technical Field

The present invention relates to a fabric, and in particular to a temperature-regulating fabric.

### Description of Related Art

In recent years, the fashion trends of clothing and fabrics have changed from focusing on appearance to function, and comfort has also become a common requirement when people wear clothing. For example, the clothes worn during exercise generally focus on air permeability and sweat dissipation; or under severe climate/temperature changes (such as indoor/outdoor temperature difference in winter, changes of ambient temperature and humidity, metabolic differences between intense exercise state and rest state of human, etc.), the clothes generally focus on the temperature regulation. Therefore, the development of functional textiles with self-regulating temperature function has become a goal that any person of ordinary skill in the art is eager to develop.

### SUMMARY

In view of this, the present invention provides a fabric that has good temperature regulation and thermal buffer property for the human body, is not easy to lose the temperature-regulating function during processing and use, and has antistatic property.

The fabric of the present invention includes a base cloth and a coating layer. The coating layer is disposed on the base cloth, wherein the coating layer includes a resin matrix and a temperature-regulating powder. Based on 100 parts by weight of the resin matrix, the content of the temperature-regulating powder ranges from 20 to 80 parts by weight, and the material of the temperature-regulating powder includes modified polyaniline.

In an embodiment of the present invention, the preparation method of the modified polyaniline includes the following steps. A long-chain fatty acid, a surfactant, water and aniline are mixed to form a mixed reactant. The first temperature of the mixed reactant is reduced to the second temperature. At the second temperature, the aqueous solution of the oxidant is added to the mixed reactant for reaction to form the modified polyaniline.

In an embodiment of the present invention, the long-chain fatty acid has the carbon number, for example, ranging from 8 to 26.

In an embodiment of the present invention, the long-chain fatty acid includes capric acid or lauric acid, and the ratio of the weight of the long-chain fatty acid to the weight of the aniline ranges, for example, from 1 to 9.

In an embodiment of the present invention, the surfactant includes sodium dodecyl sulfate (SDS), and the ratio of the weight of the surfactant to the weight of the aniline ranges, for example, from 0.625 to 0.83.

In an embodiment of the present invention, the oxidant includes potassium persulfate, and the ratio of the weight of the oxidant to the weight of the aniline ranges, for example, from 1.45 to 3.48.

In an embodiment of the present invention, the transition temperature of the modified polyaniline ranges, for example, from 30° C. to 45° C.

In an embodiment of the present invention, the heat of transition of the modified polyaniline ranges, for example, from 114 J/g to 149 J/g.

In an embodiment of the present invention, the surface resistivity of the modified polyaniline ranges, for example, from 10⁷Ω/□ to 10⁸Ω/□.

Based on the above, the fabric of the present invention includes a coating layer disposed on the base cloth, the coating includes the resin matrix and the temperature-regulating powder, and the material of the temperature-regulating powder includes the modified polyaniline, thereby the fabric has good temperature regulation and thermal buffer property for the human body, is not easy to lose the temperature-regulating function during processing and use, and has antistatic property. In this way, the product applicability and the competitiveness of the fabric are improved.

In order to make the aforementioned features and advantages of the present invention more comprehensible, embodiments are illustrated in detail hereinafter.

### BRIEF DESCRIPTION OF THE DRAWINGS

FIG. 1 is a schematic cross-sectional view of a fabric according to an embodiment of the present invention.

### DESCRIPTION OF THE EMBODIMENTS

Herein, a range represented by being from a value to another value is a schematic representative manner of preventing all values within the range from being listed one by one in the specification. Therefore, a record of a particular value range covers any value within the value range and a smaller value range defined by any value within the value range, like a case in which the any value and the smaller value range are explicitly written in the specification.

As used herein, “about”, “approximately”, “essentially” or “substantially” is inclusive of the stated value and means within an acceptable range of deviation for the particular value as determined by any person of ordinary skill in the art, considering the measurement in question and the error associated with measurement of the particular quantity (i.e., the limitations of the measurement system). For example, “about” can mean within one or more standard deviations, or within ±30%, ±20%, ±10%, ±5% of the stated value. Further, as used herein, “about”, “approximately”, “essentially” or “substantially” may depend on measurement properties or other properties to select a more acceptable range of deviations or standard deviations without one standard deviation for all properties.

In order to provide a fabric which has good temperature regulation and thermal buffer property for the human body, is not easy to lose the temperature-regulating function during processing and use, and has antistatic property, the present invention proposes a fabric that can achieve the above advantages. Hereinafter, embodiments are listed as examples in which the present invention can be actually implemented accordingly.

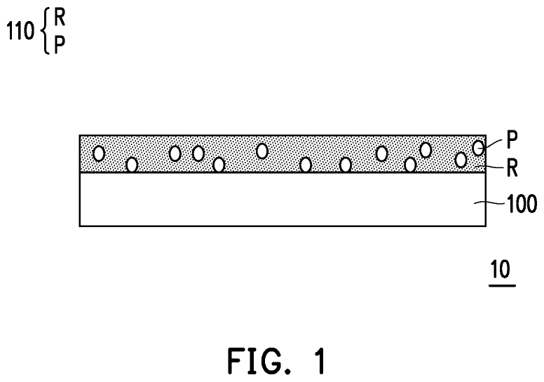

FIG. 1 is a schematic cross-sectional view of a fabric according to an embodiment of the present invention.

Referring to FIG. 1, a fabric 10 includes a base cloth 100 and a coating layer 110 disposed on the base cloth 100. In this embodiment, the fabric 10 may be clothing such as clothes, coats, or pants. In an embodiment, the coating layer 110 of the fabric 10 may directly contact the user's skin. In another embodiment, compared to the base cloth 100 of the fabric 10, the coating layer 110 of the fabric 10 may be adjacent to the user's skin, but not in direct contact with the user's skin.

In this embodiment, the base cloth 100 may be any kind of cloth known to any person of ordinary skill in the art, such as knitted cloth, woven cloth, or non-woven cloth. In this embodiment, the material of the base cloth 100 may include (but is not limited to): polyester, nylon, cotton, polypropylene, polyurethane, or a combination thereof.

In this embodiment, the coating layer 110 includes a resin matrix R and a temperature-regulating powder P dispersed in the resin matrix R. In this embodiment, based on 100 parts by weight of the resin matrix R, the content of the temperature-regulating powder P ranges from 20 parts by weight to 80 parts by weight. If the content of the temperature-regulating powder P is less than 20 parts by weight, the temperature-regulating ability of the fabric 10 is not good; and if the content of the temperature-regulating powder P is more than 80 parts by weight, the film formability of the coating layer 110 is poor, making it difficult to uniformly dispose on the base cloth 100.

In this embodiment, the material of the resin matrix R may include (but is not limited to): epoxy resin, polyurethane, polyester, acrylic resin, or a combination thereof.

In this embodiment, the material of the temperature-regulating powder P may include modified polyaniline. In detail, the modified polyaniline is a polyaniline modified with a long-chain fatty acid. In this embodiment, the preparation method of the modified polyaniline may include the following steps. First, a mixed reactant is prepared by the step of after dispersing the long-chain fatty acid and a surfactant in water to form a mixture, adding and dispersing aniline in the mixture to form the mixed reactant. However, the present invention is not limited to this. In other embodiments, after the mixture is formed, the mixture may be heated first, and then the aniline is added and dispersed in the heated mixture to form the mixed reactant.

The long-chain fatty acid may have the carbon number ranging from 8 to 26, preferably from 10 to 12. Examples of the long-chain fatty acid may include (but are not limited to): caprylic acid, capric acid, lauric acid, myristic acid, hexadecanoic acid, octadecanoic acid, arachidic acid, behenic acid, tetracosanoic acid, or cerotic acid. Examples of the surfactant may include (but are not limited to): sodium dodecyl sulfate (SDS) or hexadecyl trimethyl ammonium bromide. Water is for example deionized water. The mixture may be an emulsion, and the mixed reactant may be a stable emulsion.

The ratio of the weight of the long-chain fatty acid to the weight of the aniline may range, for example, from 1 to 9. If the ratio of the weight of the long-chain fatty acid to the weight of the aniline is less than 1, the modification rate of polyaniline is too low, resulting in insufficient active ingredients in the temperature-regulating powder P; and if the ratio of the weight of the long-chain fatty acid to the weight of the aniline is higher than 9, the adhesion between the base cloth 100 and the coating layer 110 is reduced due to the excess long-chain fatty acid. The ratio of the weight of the surfactant to the weight of the aniline may range, for example, from 0.625 to 0.83. If the ratio of the weight of surfactant to the weight of the aniline is less than 0.625, the polyaniline particles may precipitate out; and if the ratio of the weight of surfactant to the weight of the aniline is higher than 0.83, the adhesion between the base cloth 100 and the coating layer 110 is reduced.

The time required to form the mixture may range from about 15 minutes to about 30 minutes, and the time required to form the mixed reactant after adding the aniline may range from about 30 minutes to about 120 minutes. The temperature required to form the mixed reactant may range from about 30° C. to about 70° C.

Next, the mixed reactant is cooled down under agitation. Specifically, the temperature of the mixed reactant is reduced from the first temperature to the second temperature. The first temperature ranges from about 30° C. to about 70° C., the second temperature ranges from about 5° C. to about 10° C.

After that, the polymerization reaction is initiated by the step of at the second temperature, adding an aqueous solution of an oxidant to the mixed reactant for reaction to form the modified polyaniline. Examples of the oxidant may include (but are not limited to): potassium persulfate or ammonium persulfate. The ratio of the weight of the oxidant to the weight of the aniline ranges, for example, from, 1.45 to 3.48. If the ratio of the weight of the oxidant to the weight of the aniline is less than 1.45, the modified polyaniline is not easy to have a high molecular weight; and if the ratio of the weight of the oxidant to the weight of the aniline is higher than 3.48, it is easy to reduce the conductivity of the modified polyaniline. The reaction time for forming the modified polyaniline ranges from about 8 hours to about 16 hours.

The modified polyaniline formed through the above steps can be filtered, washed and dried to facilitate subsequent applications, such as for the preparation of coating layer 110.

In this embodiment, the preparation method of the coating layer 110 may include the following steps. First, after preparing the resin solution, the temperature-regulating powder P is mixed with it to form a mixed liquid. Then, after the mixed liquid is formed on the carrier, a drying process is performed to remove the solvent and form the coating layer 110 including the resin matrix R and the temperature-regulating powder P. The solvent used to prepare the resin solution is not particularly limited, as long as it can dissolve the resin. Specifically, examples of the solvent include (but are not limited to): an amide-based solvent (such as N,N-dimethylacetamide (DMAc), N,N-dimethylformamide (DMF), N,N′-diethylacetamide, N-methyl-2-pyrrolidone (NMP), γ-butyrolactone, or hexamethylphosphoramide); a urea-based solvent (such as tetramethylurea, or N,N-dimethylethylurea); an sulfoxide or sulfone-based solvent (such as dimethyl sulfoxide (DMSO), diphenyl sulfone, or tetramethyl sulfone); a halogenated alkyl-based solvent (such as chloroform or dichloromethane); an aromatic hydrocarbon-based solvent (such as benzene or toluene); a phenol-based solvent (such as phenol or cresol); or, an ether-based solvent (such as tetrahydrofuran (THF), 1,3-dioxolane, dimethyl ether, diethyl ether, or p-cresol methyl ether). The above solvents may be used alone or in combination. The method of forming the mixed liquid on the carrier may be carried out by any coating method well known to any person of ordinary skill in the art, such as blade coating method, spin coating method, air blade coating method, slot coating method, extrusion coating method, or roll coating method. However, the present invention is not limited thereto. In other embodiments, the preparation method of the coating layer 110 may include the following steps: mixing the resin (such as waterborne polyurethane, polyester, or acrylic resin) directly with the temperature-regulating powder P, and then coating on the carrier, followed by performing a curing process to remove water and form the coating layer 110 including the resin matrix R and the temperature-regulating powder P. In view of this, in an embodiment of the preparation of the fabric 10, the carrier during the preparation of the coating layer 110 mentioned-above is the base cloth 100. However, the preparation method of the fabric 10 is not limited thereto. In another embodiment, the preparation method of the fabric 10 may include disposing the formed coating layer 110 on the base cloth 100 in an adhesive manner.

In this embodiment, the temperature-regulating powder P belongs to a solid-solid transition type phase change material. That is to say, regardless of whether the temperature is lower or higher than the phase transition temperature of the temperature-regulating powder P, the temperature-regulating powder P is in a solid state. From another point of view, after an endothermic or exothermic reaction occurs, the physical state or molecular structure of the temperature-regulating powder P will change. For example, the temperature-regulating powder P will change from the first solid state to the second solid state due to an endothermic or exothermic reaction, where the molecular arrangements (such as crystal arrangements) of the first solid state and the second solid state are different. In other words, the temperature regulating powder P absorbs or releases thermal energy through its transition between two solid states, thereby playing the role of storing thermal energy. In this way, the fabric 10 including the temperature-regulating powder P has the function of regulating the temperature. Further, because the temperature-regulating powder P has always been in a solid state, the fabric 10 including the temperature-regulating powder P does not have the potential problem of shell damage encountered when a solid-liquid transition type phase change material is used, thereby the fabric 10 is not easy to lose the temperature-regulating function due to the damage of the temperature-regulating powder P during processing and use.

In addition, polyaniline is a conjugated conductive polymer, which is an intrinsic conductive polymer (ICP) with intrinsic conductivity. Therefore, after the polyaniline is modified by the long-chain fatty acid, the molecular structure of the modified polyaniline may form hole carrier or electron carrier, such that the modified polyaniline may have conductivity between the semiconductor and the metal conductor. As a result, the fabric 10 including the temperature-regulating powder P can have antistatic property or conductivity.

In this embodiment, the transition temperature of the modified polyaniline may range, for example, from about 30° C. to about 45° C. Since the transition temperature of the modified polyaniline is close to the body temperature of the human body, the fabric 10 including the temperature-regulating powder P can be applied to the human body. In addition, in this embodiment, the heat of transition of the modified polyaniline may range, for example, from about 114 J/g to about 149 J/g. As a result, the fabric 10 including the temperature-regulating powder P has good temperature regulation and thermal buffer property for the human body.

In this embodiment, the surface resistivity of the modified polyaniline may range, for example, from about 10⁷Ω/□ to about 10⁸Ω/□. In this way, the fabric 10 including the temperature-regulating powder P can have antistatic property to meet antistatic requirements.

In this embodiment, the initial decomposition temperature of the modified polyaniline is greater than about 130° C., and the maximum decomposition temperature is greater than 160° C. That is to say, the temperature-regulating powder P has good heat resistance. In this way, the fabric 10 including the temperature-regulating powder P is not easy to lose the temperature-regulating function due to high temperature during processing and use.

It is worth noting that, as mentioned above, the fabric 10 includes the coating layer 110 disposed on the base cloth 100, the coating layer 110 includes the resin matrix R and the temperature-regulating powder P, and the material of the temperature-regulating powder P includes the modified polyaniline, so that the fabric 10 has good temperature regulation and thermal buffer property for the human body, is not easy to lose the temperature-regulating function during processing and use, and has antistatic property. As a result, the product applicability and the competitiveness of the fabric 10 are improved.

Hereinafter, the features of the present invention will be more specifically described with reference to Examples 1 to 3 and Comparative Example 1. Although the following examples are described, the materials used, the amounts and ratios thereof, the processing details and the processing flow, etc. can be appropriately changed without departing from the scope of the present invention. Therefore, the present invention should not be 1 construed restrictively by the examples described below.

### Example 1

4 parts by weight of lauric acid, 0.83 parts by weight of sodium dodecyl sulfate and 125 parts by weight of deionized water were placed into a four-necked reactor preheated to about 60° C., and then were heated to about 60° C. and stirred for about 0.5 hours to disperse evenly. Next, 1 part by weight of aniline was dropped into the four-necked reactor, and the resultant mixture in the four-necked reactor was continually stirred for about 1 to 2 hours with increased stirring rate to form a fully emulsified mixed reactant. Next, the temperature of the mixed reactant was gradually reduced to 5° C., and under the temperature of 5° C., 2.4 parts by weight of potassium persulfate dissolved in 35 ml of deionized water was added dropwise to the mixed reactant, and the polymerization reaction was carried out for about 12 hours to form the modified polyaniline of Example 1. After the temperature of the reaction system returned to room temperature, the modified polyaniline of Example 1 was filtered, washed and dried to obtain a dark green powder (i.e., the modified polyaniline of Example 1).

### Example 2

4 parts by weight of capric acid, 0.83 parts by weight of sodium dodecyl sulfate and 125 parts by weight of deionized water were placed into a four-necked reactor preheated to about 60° C., and then were heated to about 60° C. and stirred for about 0.5 hours to disperse evenly. Next, 1 part by weight of aniline was dropped into the four-necked reactor, and the resultant mixture in the four-necked reactor was continually stirred for about 1 to 2 hours with increased stirring rate to form a fully emulsified mixed reactant. Next, the temperature of the mixed reactant was gradually reduced to 5° C., and under the temperature of 5° C., 2.4 parts by weight of potassium persulfate dissolved in 35 ml of deionized water was added dropwise to the mixed reactant, and the polymerization reaction was carried out for about 12 hours to form the modified polyaniline of Example 2. After the temperature of the reaction system returned to room temperature, the modified polyaniline of Example 2 was filtered, washed and dried to obtain a dark green powder (i.e., the modified polyaniline in Example 2).

### Example 3

3 parts by weight of capric acid, 0.625 parts by weight of sodium dodecyl sulfate and 125 parts by weight of deionized water were placed into a four-necked reactor preheated to about 60° C., and then were heated to about 60° C. and stirred for about 0.5 hours to disperse evenly. Next, 1 part by weight of aniline was dropped into the four-necked reactor, and the resultant mixture in the four-necked reactor was continually stirred for about 1 to 2 hours with increased stirring rate to form a fully emulsified mixed reactant. Next, the temperature of the mixed reactant was gradually reduced to 5° C., and under the temperature of 5° C., 2.4 parts by weight of potassium persulfate dissolved in 35 ml of deionized water was added dropwise to the mixed reactant, and the polymerization reaction was carried out for about 12 hours to form the modified polyaniline of Example 3. After the temperature of the reaction system returned to room temperature, the modified polyaniline of Example 3 was filtered, washed and dried to obtain a dark green powder (i.e., the modified polyaniline in Example 3).

### Comparative Example 1

In Comparative Example 1, the commercially available n-octadecane (Reagent Grade, manufactured by Alfa Aesar) was used.

The initial decomposition temperature (Tᵢ), the maximum decomposition temperature (T_{d}), the transition temperature (Tₜᵣₐₙₛ), the heat of transition (ΔHf) and the surface resistivity of each of the modified polyaniline of Examples 1-3 and the n-octadecane of Comparative Example 1 were measured. The description of the aforementioned measurement items is as follows, and the measurement results are shown in Table 1.

<Measurement of Initial Decomposition Temperature (Tᵢ) and Maximum Decomposition Temperature (T_{d})>

The modified polyanilines of Examples 1-3 and the n-octadecane of Comparative Example 1 were respectively measured under a nitrogen atmosphere at a heating rate of 20° C./min by using a thermogravimetric analyzer (manufactured by TA Instruments, model: Q50), and the change in weight of each of the modified polyanilines and the n-octadecane was recorded, where the temperature measured when each of the modified polyanilines and the n-octadecane initially lost weight was the initial decomposition temperature (° C.), and the temperature measured when the degree of weight loss was maximum was the maximum decomposition temperature (° C.).

### <Measurement of Transition Temperature (Tₜᵣₐₙₛ)>

The endothermic value and the exothermic value of each of the modified polyanilines of Examples 1-3 and the n-octadecane of Comparative Example 1 were measured under a nitrogen atmosphere at a heating rate of 10° C./min by using a thermomechanical analyzer (manufactured by Maia, model: DSC200 F3), and the endothermic peak of each of the modified polyanilines and the n-octadecane was recorded, which was taken as the transition temperature (° C.).

### <Measurement of Heat of Transition (ΔHf)>

The heat of transition (J/g) of the modified polyanilines of Examples 1-3 and the n-octadecane of Comparative Example 1 were respectively measured under a nitrogen atmosphere at a heating rate of 10° C./min by using a thermomechanical analyzer (manufactured by Maia, model: DSC200 F3).

### <Measurement of Surface Resistivity>

The surface resistivities of the modified polyanilines of Examples 1-3 and the n-octadecane of Comparative Example 1 were respectively measured by using a resistivity tester (brand name TRACK, model: MODEL-100). The standard specified by the FTTS-FA-009 was used to evaluate the conductivity, where when the surface resistivity is greater than 1×10¹²Ω/□, it represents insulating material; when the surface resistivity is between 1×10⁵Ω/□ and 1×10¹²Ω/□, it represents static dissipative material (antistatic material); when the surface resistivity is less than 1×10⁴Ω/□, it represents conductive material, and the lower the surface resistivity, the better the conductivity.

TABLE 1

| | | | | | surface |
|---|---|---|---|---|---|
| | Tᵢ | T_{d} | Tₜᵣₐₙₛ | ΔHf | resistivity |
| | (° C.) | (° C.) | (° C.) | (J/g) | (Ω/□) |
| Example 1 | 154.11 | 186.86 | 44.7 | 132.3 | 10⁷~10⁸ |
| Example 2 | 134.36 | 164.91 | 30.7 | 148.5 | 10⁷~10⁸ |
| Example 3 | 136.36 | 166.43 | 32.0 | 114.0 | 10⁷~10⁸ |
| Comparative | 90.36 | 150.62 | 30.7 | 213.7 | >10¹² |
| Example 1 | | | | | |

As can be seen from the above Table 1, compared with the initial decomposition temperature and the maximum decomposition temperature of n-octadecane in Comparative Example 1, the modified polyanilines of Examples 1-3 all have higher initial decomposition temperatures and higher maximum decomposition temperatures. The results show that the modified polyaniline of the present invention has excellent heat resistance. In this way, the fabric of the present invention including the temperature-regulating powder is not easy to lose the temperature-regulating function due to high temperature during processing and use.

In addition, as can be seen from the above Table 1, the transition temperatures of the modified polyanilines of Examples 1-3 are between 30.7° C. and 44.7° C., and the heats of transition of the modified polyanilines of Examples 1-3 are between 114 J/g and 148.5 J/g. The results show that the modified polyaniline of the present invention has a transition temperature close to the temperature of the human body and can store considerable thermal energy. In this way, the fabric of the present invention including the temperature-regulating powder has good temperature regulation and thermal buffer property for the human body.

In addition, as can be seen from the above Table 1, the modified polyanilines of Examples 1-3 all have antistatic property; while the n-octadecane of Comparative Example 1 is an insulating material.

Although the present invention is disclosed with reference to embodiments above, the embodiments are not intended to limit the present invention. Any person of ordinary skill in the art may make some variations and modifications without departing from the spirit and scope of the invention, and therefore, the protection scope of the present invention should be defined in the following claims.

What is claimed is:

1. A fabric, comprising:
a base cloth; and
a coating layer, disposed on the base cloth, wherein the coating layer comprises:
a resin matrix; and
a temperature-regulating powder, wherein based on 100 parts by weight of the resin matrix, a content of the temperature-regulating powder ranges from 20 to 80 parts by weight, and a material of the temperature-regulating powder comprises modified polyaniline.

2. The fabric according to claim 1, wherein a preparation method of the modified polyaniline comprises:
mixing a long-chain fatty acid, a surfactant, water and aniline to form a mixed reactant;
reducing a temperature of the mixed reactant from a first temperature to a second temperature; and
at the second temperature, adding an aqueous solution of an oxidant to the mixed reactant for reaction to form the modified polyaniline.

3. The fabric according to claim 2, wherein the long-chain fatty acid has a carbon number ranging from 8 to 26.

4. The fabric according to claim 2, wherein the long-chain fatty acid comprises capric acid or lauric acid, and a ratio of a weight of the long-chain fatty acid to a weight of the aniline ranges from 1 to 9.

5. The fabric according to claim 2, wherein the surfactant comprises sodium dodecyl sulfate (SDS), and a ratio of a weight of the surfactant to a weight of the aniline ranges from 0.625 to 0.83.

6. The fabric according to claim 2, wherein the oxidant comprises potassium persulfate, and a ratio of a weight of the oxidant to a weight of the aniline ranges from 1.45 to 3.48.

7. The fabric according to claim 1, wherein a transition temperature of the modified polyaniline ranges from 30° C. to 45° C.

8. The fabric according to claim 1, wherein a heat of transition of the modified polyaniline is ranges from 114 J/g to 149 J/g.

9. The fabric according to claim 1, wherein a surface resistivity of the modified polyaniline ranges from 10⁷Ω/□ to 10⁸Ω/□.
